(19) United States
(12) Patent Application Publication
(10) Pub. No.: US 2013/0302695 A1
(43) Pub. Date: Nov. 14, 2013

(54) THIN MACROPOROUS POLYMERIC FOILS

(71) Applicants: Ekkehard Beer, Bad Schwalbach (DE); Michael Kube, Haltern am See (DE); Matthias Pascaly, Frankfurt (DE)

(72) Inventors: Ekkehard Beer, Bad Schwalbach (DE); Michael Kube, Haltern am See (DE); Matthias Pascaly, Frankfurt (DE)

(73) Assignee: Evonik Degussa GmbH, Essen (DE)

(21) Appl. No.: 13/980,719

(22) PCT Filed: Dec. 22, 2011
(86) PCT No.: PCT/EP2011/073799

§ 371 Date: Jul. 19, 2013

(30) Foreign Application Priority Data
Jan. 26, 2011 (DE) 10 2011 003 186.3

(51) Int. Cl. D04H 1/541; H01M 2/16; D04H 1/54

(52) U.S. Cl. CPC D04H 1/541; D04H 1/54; H01M 2/162
USPC 429/249; 428/131; 156/62.6

(57) ABSTRACT

The invention relates to a foil which includes polymeric fibres, the polymeric fibres of which are interwelded, more particularly heat welded, solvent welded, cold welded, ultrasonically welded and/or at least partly interfused or positively or nonpositively interconnected at the crossing points between the pores at least, a process for production thereof, and also use thereof.

The invention relates to a foil that includes polymeric fibres which are interwelded, more particularly heat welded, solvent welded, cold welded, ultrasonically welded and/or at least partly interfused or positively or nonpositively interconnected, at the crossing points between the pores at least.

Fibre in the context of the present invention is to be understood as meaning a body which is thin relative to its length, flexible and only able to absorb tensile forces and not compressive forces. Fibres buckle on being subjected to a compressive load. Fibres usually occur in nature and industry as part of a larger ensemble, they form a certain structure. Filaments are fibres of very long, virtually unlimited length, while staple fibres have limited length. Staple fibres in turn subdivide into spinnable fibres and, below a length limit of about 15 mm, flockable fibres. In contradistinction thereto, a yarn is used by German standard specification DIN 60900 as a collective term for all linear textile bodies. Accordingly, a yarn is by analogy a long thin body composed of one or more fibres. It is a textile intermediate product which can be processed into wovens, knits and embroideries or else be used for sewing.

Porous foils are typically obtained by foils, for example polymeric films, being apertured or their original structure being damaged mechanically or chemically. Materials of this type can be used for a variety of purposes, for example as packaging materials, separation and filtration membranes or as battery separators.

German patent application DE 10 2009 047 440 discloses production and properties of thin perforated foils stable to coating or impregnation processes. The foils contain or are of metal or polymer and are apertured using a laser that emits at a suitable wavelength.

Their open area is an important parameter for characterizing perforate materials. It is due to the pores and is determined by considering the material as a two-dimensional body and expressing the area occupied by the pores relative to the total area occupied by the material. When the pores form a regular arrangement, it is possible to find unit cells which can be used as the basis for determining the open area. The edge length of areal pieces can be chosen for example to be equal to 100 times the pore diameter.

Tensile strength, abbreviated Fₘₐₓ, is a further important parameter for the processing of perforate material. In the context of the invention, it is determined in accordance with DIN EN ISO 527-1.

The object of the present invention is to provide an alternative perforate material whose open area is simple to control while thickness is minimal and tensile strength is good.

It was found that a porous foil is obtained when a woven or loop-formingly knitted fabric which includes or consists of polymeric fibres is densified such that the fibres are interwelded and/or at least partly interfused or positively or nonpositively interconnected at their crossing points at least. Following such a treatment, the fibres will have lost their original shape in cross section, but they are still identifiable as such under an optical microscope for example. The macroscopic body, by contrast, no longer has the properties of a conventional woven or knitted fabric in that it is no longer possible to separate off individual threads or fibres.

The invention thus provides a porous foil characterized in that the foil includes polymeric fibres which are interwelded, more particularly heat welded, solvent welded, cold welded, ultrasonically welded and/or at least partly interfused or positively or nonpositively interconnected at the crossing points between the pores at least.

The porous foil according to the invention has the advantage of a homogeneous structure and also of good tensile strength in both the longitudinal and the transverse direction.

A further advantage is that the claimed foil is easy to wind up without the winding-up being hindered by the bonds between the fibres at the crossing points. This foil winds up, moreover, without breakage either of the individual fibres or of the bonds at the crossing points.

The invention likewise provides a process for producing the porous foil which is characterized in that a woven or loop-formingly knitted fabric which includes or consists of thermoplastic polymeric fibres is densified one or more times under an area or line pressure, wherein the polymeric fibres become interwelded, more particularly heat welded, solvent welded, cold welded, ultrasonically welded and/or at least partly interfused or positively or nonpositively interconnected at the crossing points at least. This takes place at an area or line pressure of not more than 500 N/mm and a temperature of not more than 50% below the melting temperature of the lowest-melting polymer.

The process according to the invention has the advantage that the macroscopic thickness of the foil obtained can be adjusted, via continuously adjustable line pressure in the roll nip of a calender or of a belt press at densification, and also by adjusting the temperature of rolls. The process according to the invention is further advantageous in that thin foils having thicknesses of not more than 200 μm, preferably not more than 50 μm and more preferably extremely thin foils having thicknesses of not more than 20 μm are obtained. The choice of mesh size and thread diameter and also the conditions at densification, viz. line pressure, nip size and temperature, also serves to control the open area and the hole size. Moreover, batchwise fabrication of foils is possible in platen presses under the same control factors. These processes more particularly enable porous foil produced in this way to be used as a component of the separator in high performance batteries, for example as backing to a ceramic coating of the separator. Examples of separators including ceramic coatings are described in the patent applications DE 19741498, DE 19811708, DE 19812035, DE 19820580, DE 19824666, DE 10142622, DE 10208280, DE 10208277, DE 10238941, DE 10238944, DE 10238945, DE 10240032, DE 10255121, DE 10255122, DE 10347570, DE 10347569, DE 10347566, DE 10347568, DE 10347567, DE 10 2004 018929, DE 10 2004 018930, DE 10 2005 029124, DE 10 2005 042215, DE 10 2007 005156 DE 10 2009 002680.

The invention accordingly also provides the foil obtained according to the process and for the use of the foil according to the invention or obtained according to the invention as separator in batteries, also as packaging material, membrane, filter, and as backing material for ceramic composite membranes.

An example of a possible use for the foil according to the invention is as backing to a ceramic coating in the production of ceramic separators, for example of SEPARION® separator, which has thermal and chemical resistance and hence is particularly suitable for use in lithium ion batteries capable of high performance.

The invention accordingly also provides a lithium ion battery that includes the foil according to the invention as separator.

The invention will now be more particularly elucidated.

The foil according to the invention can have a thickness of not more than 100 μm and/or an open area of not less than 20%. This makes it suitable for use as separator in a battery. It is particularly preferable for the foil to have a thickness of not more than 20 μm. This makes it suitable for use as separator in a high performance battery and more preferably in a lithium ion battery.

The fibres of the foil according to the invention may advantageously contain or consist of a plastic of low melting point. An example of a partially melting polymer is polyethylene terephthalate (PET), which melts at 210-235° C.

Vestamelt® may be a preferable plastic. A further embodiment of the invention advantageously comprises mixtures of fibres capable of effectuating fusion/melting, more preferably polyester fibres in the longitudinal direction and polyolefin fibres in the transverse direction.

The polymeric fibres of the foil according to the invention may include or consist of at least one thermoplastic polymer. More preferably, the polymer of these fibres may be selected from polyacrylonitrile, polyester, polyamide, polyimide, polyaramid, polyolefins, PTFE, PVDF, PES, PUR or a combination thereof.

It is further particularly preferable for the polymeric fibres of the foil according to the invention to include or consist of at least one thermoplastic and at least one nonthermoplastic polymer, core-shell fibres and/or coextrudates.

When the polymeric fibres of the foil according to the invention include at least one thermoplastic and at least one nonthermoplastic polymer, these may be selected from
core-shell fibres wherein the core material includes or is at least one nonthermoplastic polymer,
coextruded fibres,
thermoplastic polymeric fibres in the warp direction and nonthermoplastic polymeric fibres in the weft direction,
nonthermoplastic polymeric fibres in the warp direction and thermoplastic polymeric fibres in the weft direction,
polymeric fibres which include finer thermoplastic and nonthermoplastic polymeric fibres or consist of such a fibre blend, or
   be a combination of these fibres.

The foil according to the invention, which includes polymeric fibres of or comprising thermoplastic and nonthermoplastic polymer, has the advantage that the foil according to the invention or obtained according to the invention has greater tensile strength than a foil consisting of an extruded polymeric compound. It is a particular advantage that such a foil is calenderable or further processible, for example heat-treatable, in reel-to-reel processes. It is a very particular advantage that the foil according to the invention or obtained according to the invention can be coated with ceramic material and subsequently heat-treated, for example in the production of SEPARION® separator. The foil further has the advantage that its tensile strength can be adapted to the requirements of calendering, for example by selecting nonthermoplastic polymer for the fibres in the warp direction. The foil additionally has the advantage that particularly thin foils can be obtained by selecting particularly thin thermoplastic and/or nonthermoplastic polymeric fibres.

A thermoset polymeric fibre core moreover endows the foil according to the invention with more strength. This selection also influences the thickness of the porous foil, since the material is not so easily formable. True, the foil according to the invention does have higher stability and hence low deformability and a higher shear modulus, but it behaves less elastically in the calender nip.

It is particularly preferable for the polymeric fibres to be sheathed fibres, which are obtainable by processes known to a person skilled in the art, for example the so-called bicomponent spinning or the process of coextrusion. Among the multiplicity of sheathed fibres, it is for example those having a PET core sheathed with PA which may be particularly preferable.

Preferable fibres further also include staple fibres in spunbonded form or very short and fine meltblown fibres, which are obtainable from Fare SpA, Via Pastrengo 31, Fagnono, Olona (VA), 21054, Italy.

In addition to the above, any further combination of fibres and polymers which is known for textiles among those skilled in the art is possible.

Furthermore, the foils according to the invention and/or obtained according to the invention are convertible into ceramic composite membranes by coating with ceramic dispersions. An example of the prior art is SEPARION®, where a nonwoven web of polymeric fibre is used in place of an apertured polymeric film.

The invention further provides a process for producing the porous foil according to the invention, which process is characterized in that a woven or loop-formingly knitted fabric which includes or consists of thermoplastic polymeric fibres is densified one or more times under an area or line pressure of not more than 500 N/mm and a temperature not more than 50% below the melting temperature of the lowest-melting polymer, wherein the polymeric fibres become interwelded, more particularly heat welded, solvent welded, cold welded, ultrasonically welded and/or at least partly interfused or positively or nonpositively interconnected at the crossing points at least.

Preferably, the woven or loop-formingly knitted fabric is densified continuously in calenders or belt presses. Preferably, a line pressure of not more than 500 N/mm is used. It is further preferable to use platen presses for a batchwise operation. It is similarly preferable to choose a temperature not more than 10% below the melting temperature of the lowest-melting polymer.

In an advantageous embodiment of the process according to the invention, the woven or loop-formingly knitted fabric is densified two or more times, wherein every further densification differs from the preceding densification in line pressure, nip size and/or temperature.

The wovens and loop-formed knits are produced in accordance with the prior art, for example at Andritz in Krefeld, Webatex in Bayreuth or Sefar Schweiz, as well as the further processing according to the invention using a calender.

One advantage of at least one further calendering is the additional functionality, preferably through application of a further woven or nonwoven fabric. It may be preferable for an extremely thin aramid nonwoven to be calendered on.

### INVENTIVE EXAMPLES 1 TO 4

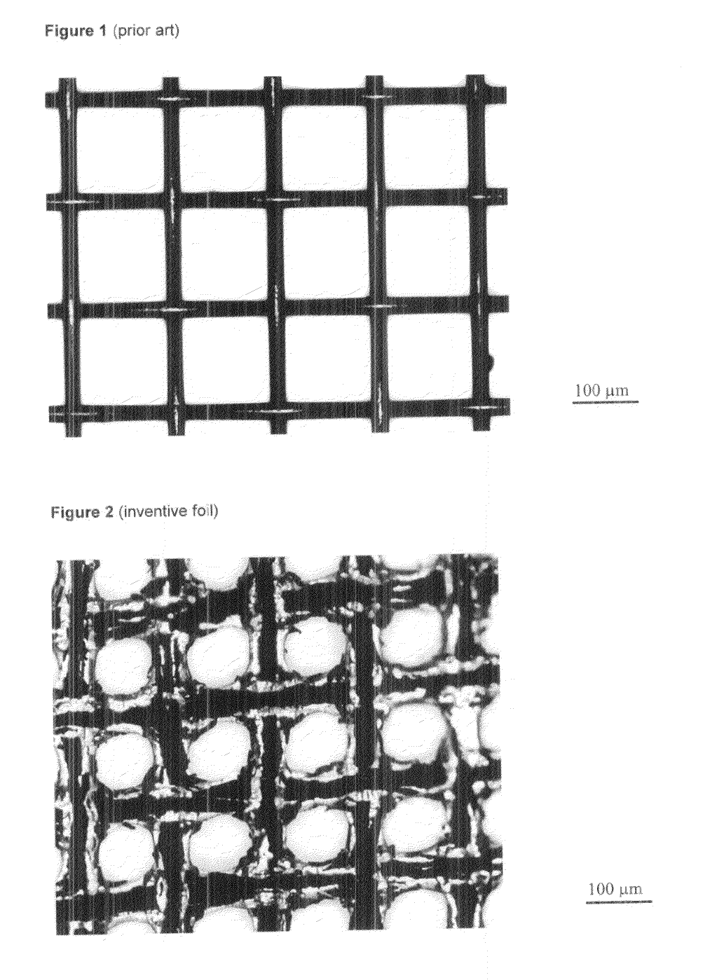

Woven polyethylene terephthalate (PET) fabric with 10 dtex, corresponding to a monofil 27 μm, mesh size 135 μm and a thickness of 44 μm, shown in FIG. 1, was calendered under various line pressures, temperatures and transport speeds.

Tensile strengths were determined in accordance with DIN EN ISO 527-1 in both the material direction (MD) and in the cross direction (CD) which are known to a person skilled in the art. The results are shown in Table 1.

A line pressure of 300 N/mm, a transport speed of 10 m/min and a temperature of 220° C. resulted in an inventive porous foil having a thickness of 14 μm being obtained. The tensile strengths measured are shown in line 1 of Table 1.

The tensile strengths of the inventive foil obtained on calendering the fabric at a line pressure of 150 N/mm, a transport speed of 3 m/min and a temperature of 210° C. are reported in line 2.

Line 3 shows the tensile strengths of the inventive foil obtained from the same fabric at a line pressure of 250 N/mm, a transport speed of 3 m/min and a temperature of 210° C. This foil is shown in FIG. 2.

Line 4 shows the tensile strengths of the inventive foil obtained from the same fabric at a line pressure of 300 N/mm, a transport speed of 3 m/min and a temperature of 210° C.

### COMPARATIVE EXAMPLES 5 AND 6

Commercially available PET foils having thicknesses of 18 μm and 11 μm were two-dimensionally apertured using a laser. This sheetlike aperturing can be effected using CO₂ lasers. The process is in line with the one-dimensional aperturing as practised for example by Maag or Micro Laser Tech and as disclosed inter alia in the patent documents JP63023936 or JP11077872.

The resulting apertured foils had an open area of 22% and 15%, respectively, as summarized in lines 5 and 6 of Table 1, respectively.

No CD tensile strength is reported for the 11 μm apertured foil at item 6 because of failure to reach the lower limit of the measurement range.

TABLE 1

| | | | | Tensile strength | |
|---|---|---|---|---|---|
| | | | Open | Fₘₐₓ | |
| Specimen | | Thickness | area | MD | CD |
| Example | | (μm) | (%) | (N/cm) | (N/cm) |
| 1. | inventive porous foil | 14 | 34 | 14 | 14 |
| 2. | inventive porous foil | 18 | 28 | 8 | 8 |
| 3. | inventive porous foil | 12 | 21 | 5 | 5 |
| 4. | inventive porous foil | 10 | 23 | 5 | 5 |
| 5. | apertured PET foil | 18 | 22 | 4 | 3 |
| 6. | apertured PET foil | 11 | 15 | 4 | — |

1. A porous foil,
comprising:
interwelded polymeric fibres,
wherein the polymeric fibres are heat welded, solvent welded, cold welded, ultrasonically welded, at least partly interfused or positively or nonpositively interconnected at crossing points between pores, or any combination thereof.

2. The foil according to claim 1, wherein the foil has a thickness of not more than 100 μm, an open area of not less than 20%, or both.

3. The foil according to claim 1,
wherein
the polymeric fibres comprise a thermoplastic polymer.

4. The foil according to claim 3,
wherein
the thermoplastic polymer is at least one selected from the group consisting of polyacrylonitrile, polyester, polyamide, polyimide, polyaramid, polyolefin, PTFE, PVDF, PES, and PUR.

5. The foil according to claim 1,
wherein
the polymeric fibres comprise a thermoplastic polymer, a nonthermoplastic polymer, a core-shell fibre, or a coextrudate.

6. A process for producing the foil according to claim 1, the process comprising:
densifying a woven or loop-formingly knitted fabric comprising the polymeric fibres one or more times under an area or line pressure of not more than 500 N/mm and a temperature of not more than 50% below a melting temperature of a polymer with the lowest melting temperature,
wherein the woven or loop-formingly knitted fabric comprises thermoplastic polymeric fibres.

7. The process according to claim 6,
wherein
the woven or loop-formingly knitted fabric is densified two or more times, and
every subsequent densification differs from a preceding densification in at least one of line pressure, nip size, and temperature.

8. A porous foil obtained by the process according to claim 6.

9. A separator in batteries, a packaging material, a membrane, a backing material for ceramic composite membranes, or a filter, comprising: the foil according to claim 1.

10. A lithium ion battery, comprising:
a separator comprising the foil according to claim 1.

11. The foil according to claim 1, wherein the foil has a thickness of 50 μm, an open area of not less than 20%, or both.

12. The foil according to claim 1, wherein the foil has a thickness of not more than 20 μm, an open area of not less than 20%, or both.
